(19) United States
(12) Patent Application Publication
(10) Pub. No.: US 2007/0091598 A1
(43) Pub. Date: Apr. 26, 2007

(54) Low-voltage LED garden lights

(76) Inventor: Chi Gon Chen, Guang Zhou (CN)

Correspondence Address: STRASBURGER & PRICE, LLP, 901 MAIN STREET, SUITE 4400, DALLAS, TX, 75202, US

(21) Appl. No.: 11/541,214

(22) Filed: Sep. 29, 2006

Related U.S. Application Data
(60) Provisional application No. 60/754,407, filed on Dec. 28, 2005.
(60) Provisional application No. 60/784,613, filed on Mar. 22, 2006.
(60) Provisional application No. 60/722,062, filed on Sep. 29, 2005.
(60) Provisional application No. 60/725,410, filed on Oct. 11, 2005.

(51) Int. Cl. F21V 21/00

(52) U.S. Cl. 362/231; 362/249

(57) ABSTRACT

A low cost, low voltage garden light system is disclosed. A transformer to convert 120 v AC to 12V DC is connected to a series of outdoor light fixtures. Each outdoor light fixture contains one or more LED bulbs. The LED bulb includes a hollow enclosure and a lower cover assembly. The lower cover assembly includes a circuit which permits the connecting pins to be inserted into a two hole socket in either direction. The LEDs are mounted to expose their leads to ambient air to assist in cooling. The hollow enclosure includes reflective surfaces therein and a top reflector which also may include a reflecting surface therein.

### CROSS-REFERENCE TO RELATED APPLICATIONS

This utility patent application makes reference to and seeks the benefit of the following U.S. Provisional Patent Applications: 1) 60/754407 filed Dec. 28, 2005, 2) 60/784613 filed Mar. 22, 2006, 3) 60/722062 filed Sep. 29, 2005 and 4) 60/725410 filed Oct. 11, 2005.

### STATEMENT REGARDING FEDERALLY SPONSORED RESEARCH OR DEVELOPMENT

The invention described in this application was not the subject of federally sponsored research or development.

### FIELD

The present invention pertains to outdoor lights; more particularly, the present invention pertains to outdoor lights typically used in residential applications to light walkways or to provide decorative illumination in yards or gardens.

### BACKGROUND

In recent years, a popular product for homeowners has been a system of lights that are used to light a walkway leading up to the front door of a residence, to accent the border of a patio or outdoor space, or to decorate a yard or a garden. Others use the lights near a walkway as a safety precaution to properly direct those using the walkway onto its hard surface. These systems of lights are designed to use the commonly available 120 v AC electrical energy found in most U.S. residences. A transformer reduces the voltage from 120 v AC house current to a much lower level, such as 11 volts, 12 volts, or 16 volts. The reduced voltage AC is then provided to a series of low-voltage incandescent lamps which are connected one to another by electrical wiring. For decorative purposes, the low-voltage lamps are contained in a wide variety of stylized fixtures. Homeowners select stylized fixtures to blend with other light fixtures being used or to match the decor of their residence.

Some of the low-voltage AC lighting systems for residential use also include a mechanical timer. The mechanical timer is typically set to provide electrical power to the low-voltage lamps beginning at dusk and ending either a few hours later or in the early morning.

The popularity of low-voltage AC lighting systems for residential use is due to the dramatic impact that these systems can make on the appearance of a house or a yard for a relatively low cost. Additionally, these systems have become quite popular because of the ease with which a low-voltage AC lighting system is installed. Specifically, the homeowner simply pushes a stake at the bottom of each fixture into the ground, covers over the wire between the fixtures with some dirt, connects the transformer to house current, and sets the timer—and the system is operational.

In some more advanced lighting systems, each light fixture has a small connector with internal pins. For these systems, the small connector with internal pins allows the lighting fixtures to be placed anywhere along the wire conducting the low-voltage AC away from the transformer. The internal pins are configured to pierce the insulation on the wire conducting the low-voltage AC away from the transformer, thus giving the user the ability to locate the light fixture at a desired location on the wire.

While low-voltage garden-style lighting has become popular, it is not without its problems. The lamps provided in low-voltage garden-style lighting blow out frequently and must be regularly replaced. It has also been found that the cost of prior-art low-voltage garden-style lighting is above what many consumers are willing to pay for such lighting. Accordingly, there is a need in the art for a low-cost low-voltage garden-style lighting system that will provide greater reliability.

In the past several years, there has been an explosion in the use of light emitting diodes (LEDs) in a variety of applications. Initially, LEDs were small and did not provide a significant degree of illumination. Accordingly, LEDs were often used as indicator lights and not as a source of illumination. However, as the technology surrounding the construction and use of LEDs has progressed, LEDs are now being used in many illumination applications where incandescent lamps were once previously used. However, since the amount of light produced by LEDs is still small in comparison to many incandescent lamps, there remains a need in the art to maximize the illumination provided by one or more LEDs and to place the LEDs in a package similar to an incandescent light for user convenience.

### SUMMARY

The present invention provides a combination of a low cost, low voltage power supply with a new LED bulb which, using a new design of interior light reflection, produces more illumination than that of a simple collection of multiple LED's. The garden lights of the present invention also include electronic circuitry which permits the LED bulb to be inserted without regard to polarity. Additionally, the low-cost, reliable low-voltage garden-style lighting system of the present invention, includes: 1) an electronic base transformer for converting 120-volt AC house current to a 12-volt DC, 2) an electrical power supply line extending from said transformer, 3) one or more light fixtures attached to said power line, and 4) light fixtures which include a socket and at least one LED.

### BRIEF DESCRIPTION OF THE DRAWING FIGURES

A better understanding of the Low Voltage LED Garden Light System of the present invention may be had from the attached drawing figures, wherein:

FIG. 1 is a schematic drawing of a garden light set using the LED bulb and low voltage power source of the present invention;

FIG. 2A is an elevational view of the LED bulb in partial section;

FIG. 2B is an exploded perspective view of the LED bulb shown in FIG. 2A with the LEDs removed;

FIG. 3A is an exploded perspective view similar to FIG. 2B showing an LED bulb with four LEDs;

FIG. 3B is an exploded perspective view similar to FIG. 2B showing an LED bulb with six LEDs; and

FIG. 4 is a circuit diagram of the internal circuitry within the LED bulb which allows the pins on the bottom of the LED bulb to be placed in either opening in a socket having two openings.

### DESCRIPTION OF THE EMBODIMENTS

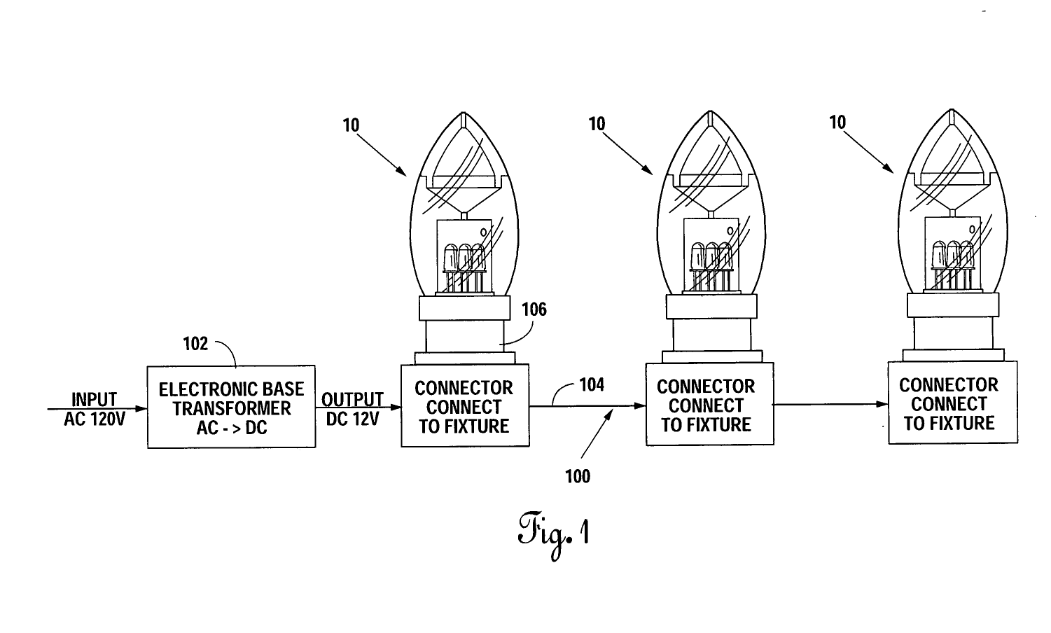

While there are many applications for the Low Voltage Garden Lights of the present invention, FIG. 1 illustrates the use of the LED bulb 10 of the present invention in garden lights 100. At the left side of FIG. 1 is a source of electrical power; typically 120 v AC house current. Because LEDs use low voltage direct current, the 120 v AC house current passes through a transformer 102 which converts the 120 v AC house current to 12 v DC. The 12-volt DC is supplied to a main secondary cable. For 15 fixtures, a 5-watt transformer has provided a satisfactory level of power. For 30 fixtures, a 10-watt transformer may be used. Those of ordinary skill in the art will understand that the use of such low-wattage transformers will produce about a 90% reduction in the power utilized by a system including low-wattage incandescent lamps. The 12 v DC passes through an electrical conductor or wires 104 to a plurality of sockets 106 , each of which has two openings sized to accommodate the pin connectors on the bottom of an LED bulb 10. Thus, the LED bulbs 10 are removable from the sockets 106 for replacement as needed.

In the preferred embodiment, the electronic base transformer will also include an electronic timer which allows a user to set a time of day for the lights to come on and another time of day for the lights to turn off or a photo cell that operates the system from dusk to dawn.

Each of the light fixtures in the low-voltage garden-style lighting system includes a connecting adaptor having copper needles therein. These copper needles pierce the insulation around the main secondary cable so that the lighting fixtures can be located as desired on the main secondary cable, and direct current can be provided to the light fixtures.

Each one of the light fixtures includes a socket for mounting an LED lamp and an LED lamp. These LED lamps provide several advantages over incandescent LED lamps. These advantages are lower power consumption, lower glare, and substantially longer life. In addition, LED lamps are available in several colors, such as red, white, green, blue, and yellow. Accordingly, users can easily change the color of the LED lamps 10 to provide decorative lighting to match seasons or holiday decorations. Heretofore, prior-art low-voltage incandescent lamps were not offered in a range of colors.

As may be seen in FIGS. 1, 2A, 2B, 3A, and 3B, in the preferred embodiment of the LED bulb 10, a bullet or flame shaped enclosure assembly 20 is used. Those of ordinary skill in the art will understand that numerous other shaped enclosure assemblies may be used depending on the size constraints and the amount of dispersion needed for the light emitted from the LEDs 90.

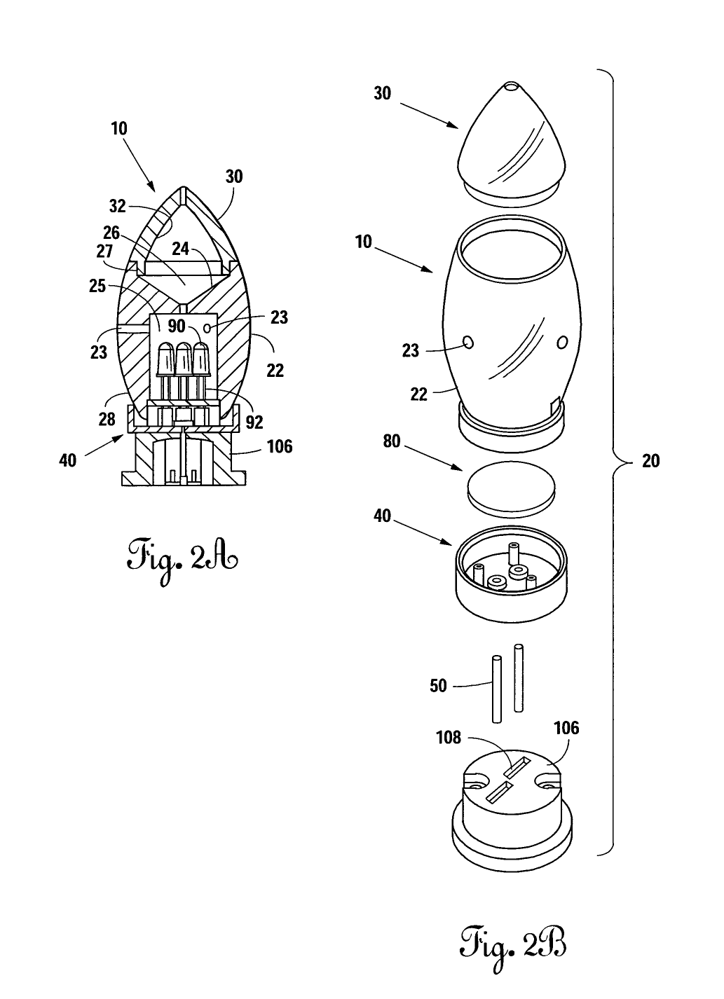

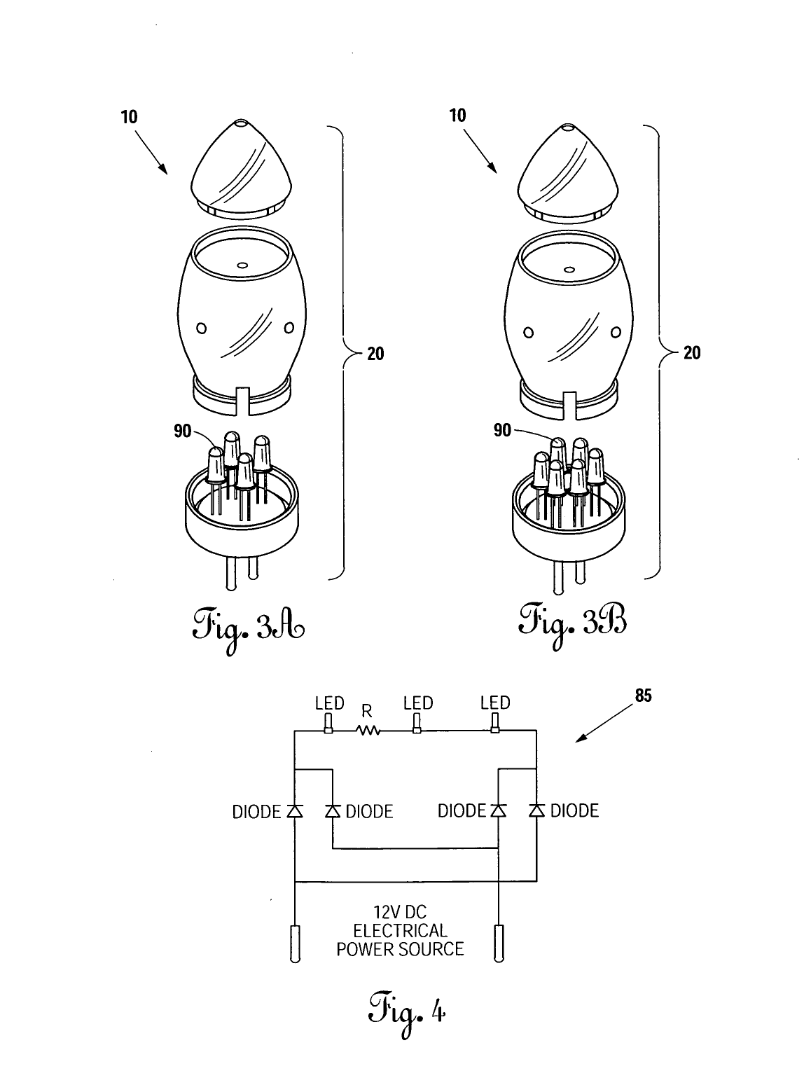

The construction of the LED bulb 10 of the present invention is best understood by reference to FIGS. 2A and 2B. As may be seen in FIG. 2A, the illustrated LED bulb 10 includes three LEDs 90. As shown in FIG. 3A and 3B other numbers of LEDs 90 may be used in the LED bulb 10 without departing from the scope of the invention. While it is expected that white or off-white LEDs 90 will be used in most applications, any color LED 90 or any combination of colored LEDs 90 may be used. The LEDs 90 are located in an opening 25 within the central hollow enclosure portion 22 of the enclosure assembly 20. The top portion 21 of the central portion 22 of the enclosure assembly 20 includes a concave opening 26. Fitting into a shouldered recess 27 at the top of the concave opening 26 is a hollow top portion 30. Surrounding the bottom 28 of the central portion 22 of the enclosure assembly 20 is a lower cover assembly 40 through which two terminal pins 50 extend.

Because LED lamps have a polarity, they generally must be placed in their sockets in a predetermined way. According to the present invention, the LED lamps can be placed in their sockets either way, and the electrical circuity within the system, as shown in FIG. 4, will assure that the polarity of the power supply circuitry matches the LED lamp. As known to those of ordinary skill in the art LEDs are electrically polarized and will only illuminate when properly polarized electrical energy is supplied.

The terminal pins 50 receive electrical energy when plugged into openings 108 in a socket 106. This electrical energy is conducted to an integrated circuit on a chip or wafer 80 sized to fit within the lower cover assembly 40. An example of the integrated circuit 85 included in the chip or wafer 80 appears in FIG. 4. The arrangement of the diodes and the resistor R assure that the terminal pins 50 can be put in either opening 108 in a two-holed socket 106 and electrical energy of the proper polarity will be supplied to the LEDs 90.

Connecting the leads 92 from the LEDs 90 to a power source is a pair of terminal pins 50. The terminal pins 50 are connected to an electrical circuit 85 within the LED bulb 10 which permits electrical energy to flow only in only one direction to the one or more LEDs 90 within the LED bulb 10. Such circuits 85 are well known to those of ordinary skill in the art who use a polarized power source to provide electrical energy. The terminal pins 50 are the same size so that there is no need to identify the polarity of the LEDs 90, and the LED bulb 10 of the present invention may be placed in a socket 106 irrespective of the orientation of the terminal pins 50.

The bottom of the hollow top portion 30 of the bullet-shaped enclosure assembly 20 is shaped to fit within a shoulder recess 27. The space 25 within the enclosure assembly 20 of sufficient size to accommodate one or more LEDs 90. When illuminated, the emitted light from the LEDs 90 will reflect from the sides of the concave opening 26 and from the interior surface 32 of the hollow top portion 30. This reflection of emitted light will cause the central portion 22 and the top portion 30 of the enclosure assembly 20 to give the appearance of being filled with light.

Because LEDs 90 which are used for illumination purposes also emit a lot of heat, the central portion 22 of the bullet-shaped enclosure assembly 20 includes one or more vent holes 23 to promote the entry of ambient air into the space 25 within the bullet-shaped enclosure assembly 20. To provide additional cooling, the LEDs 90 are mounted so that they are elevated to a position near the midst of the opening 25 within the enclosure assembly 20. Such mounting exposes a portion of the leads 92 from the LEDs 90 to ambient air. This exposure of a portion of the leads 92 to ambient air assists in conducting heat away from the LEDs 90.

In FIGS. 3A and 3B it may be seen that the light emitted by the LED 90 is dispersed by multiple reflective surfaces. The first reflective surface is within the LED 90 itself. The second reflective surface is the side walls 24 of the conical opening 26 formed in the top of the central portion 22 of the enclosure assembly 20. The third reflective surface 32 which reflects light from the individual LEDs 90 is the inside 32 of the conical opening within the hollow top portion 30 of the enclosure assembly 20.

Manufacture of the LED bulb utilized in the present invention may be accomplished in a variety of ways; however, workable LED bulbs 10 have been produced using the following steps:

mounting the electrically polarized LEDs 90 to a miniaturized circuit 85 having terminal pins 50 extending therefrom. The circuit 85 assures that the LEDs 90 receive electrical energy in the needed polarity to properly illuminate;

placing the LEDs 90 and a wafer containing the circuit 85 in the lower cover assembly 40;

placing the central portion 22 of the enclosure assembly 20 including at least one reflective surface therein over the LEDs 90 such that central portion 22 of the enclosure assembly 20 engages the lower cover assembly 40;

placing the hollow top portion 30 including at least one reflective surface 32 therein on the central portion 22 of the enclosure assembly 20.

While the LED bulb 10 utilized in the present invention has been described in terms of its preferred embodiment in what some might call a flame or bullet shaped enclosure assembly, those of ordinary skill in the art will understand that numerous other designs of enclosure assemblies may be used without departing from the disclosed invention. Such other systems may include cylinders with round or flat sides, spheres, cones, or the typical bulbous shape found in many incandescent light bulbs.

Those familiar with LED lamps will realize that the service life of an LED lamp is about 10,000 hours. That is significantly longer than the service life of a low-voltage incandescent lamp. Accordingly, the system of the present invention will provide much longer service life than the low-voltage system with incandescent lamps, without any maintenance or lamp replacement.

Finally, those familiar with LED lamps and the cost of electrical components will understand that the cost of the various components in the disclosed lighting system is significantly less than the cost of the components in a low-voltage lighting system using incandescent lamps. Accordingly, the disclosed system will be attractive to those previously not willing to pay the cost of a system with incandescent lights.

The low voltage garden lights of the present invention maximizes the illumination produced by a set of LEDs and places the LEDs in a package which is easily handled and replaced as needed for user convenience. In addition, the LEDs are wired so that the prongs or terminal pin connectors located on the base of the LED bulb of the present invention may be placed in a socket in either direction. To prolong the life of the LEDs within the LED bulb, the mounting of the LEDs within the LED bulb promotes cooling of the LEDs. Maximization of illumination is accomplished by the use of multiple reflective surfaces within the LED bulb to disperse the light rays emitted by the LEDs within the LED bulb enclosure.

While the present invention has been disclosed according to a preferred embodiment, those of ordinary skill in the art will understand that other embodiments of the disclosed invention will be enabled by the foregoing disclosure. Such other embodiments shall be included within the scope and meaning of the appended claims.

What is claimed is:

1. A low-voltage lighting system for residential applications comprising:
a transformer for converting house current to a lower voltage;
an electrical power supply line extending from said transformer;
a plurality of light fixtures attached to said power supply line;
each of said light fixtures including a socket and at least one LED lamp.

2. The low-voltage system, as defined in claim 1, further including circuitry to accommodate for the polarity of said socket and said at least one LED lamp whereby said at least one LED lamp need not be inserted into said socket in a particular manner.

3. An LED light bulb for use in a low-voltage lighting system comprising:
one or more LEDs;
a mounting for said one or more LEDs, said mounting including:
a set of leads to said set of LEDs having a sufficient length so that heat may be dissipated from said leads;
a circuit allowing the light bulb to be connected to a polarized source of electrical power in either direction;
an enclosure for said set of LEDs;
at least one reflective surface within said hollow enclosure for dispersing the light emitted by said one or more LEDs.

4. The LED light bulb as defined in claim 3 wherein said hollow enclosure is bullet shaped.

5. The LED light bulb as defined in claim 3 wherein said hollow enclosure includes a separable hollow top portion.

6. A socket mounted lighting system including one or more electrically polarized LEDs as a light source, said socket mounted lighting system comprising:
a mounting base, said mounting base including two electrical contacts for providing electrical energy to the electrically polarized LEDs irrespective of the orientation of the mounting base in the socket;
a vented enclosure constructed and arranged for interfitment with said mounting base, said vented enclosure including an opening for surrounding the one or more electrically polarized LEDs, said vented enclosure further including at least one surface for reflection of the light emitted by the one or more electrically polarized LEDs.

7. The socket mounted lighting system as defined in claim 6 wherein said vented enclosure is bullet shaped.

8. The socket mounting lighting system as defined in claim 6 wherein said vented enclosure includes a separable top portion.

9. A changeable bulb including at least one LED light source, said changeable bulb comprising:
a mounting base, said mounting base including contacts for conducting electrical energy to the at least one LED;
a circuit for receiving electrical energy from said contacts and transforming said electrical energy into a polarity usable by the at least one LED, said circuit being included within said mounting base;
a hollow enclosure constructed and arranged to be supported by said mounting base,
said hollow enclosure being further constructed and arranged to surround said at least one LED light source
at least one reflecting surface formed within said hollow enclosure for dispersing the light emitted by the at least one LED light source.

10. A garden lighting device, said garden lighting device comprising:
a plurality of sockets;
an electrical conductor for providing electrical energy to said plurality of sockets from a source of electrical energy;
a plurality of bulbs, each of said plurality of bulbs including at least one LED as a light source;
each of said plurality of bulbs including:
a mounting base, said mounting base including two electrical contacts for providing electrical energy to said at least one LED;
an enclosure constructed and arranged for interfitment with said mounting base, said enclosure including an opening for surrounding said one or more LEDs, said enclosure further including at least one surface for reflection of the light emitted by said one or more LEDs.

11. A method of manufacturing a light bulb used in outdoor garden lights including at least one or more electrically polarized LEDs, said method comprising the steps of:
mounting the electrically polarized LEDs in a base assembly, said base assembly having a pair of electrical connections;
including within said base assembly a circuit for providing electrical energy to the electrically polarized LEDs to cause them to illuminate;
surrounding the one or more electrically polarized LEDs in an enclosure, said enclosure being constructed and arranged to mount to said base assembly;
including one or more reflective surface within said enclosure for dispersing the light emitted by the one or more electrically polarized LEDs.

12. The method as defined in claim 11 wherein the at least one or more LEDs are mounted in the base assembly to expose a portion of the leads thereto to ambient air.
